(19) United States
(12) Patent Application Publication
(10) Pub. No.: US 2024/0314200 A1
(43) Pub. Date: Sep. 19, 2024

(54) EDGE DEVICE, EDGE SERVER AND SYNCHRONIZATION THEREOF FOR IMPROVING DISTRIBUTED TRAINING OF AN ARTIFICIAL INTELLIGENCE (AI) MODEL IN AN AI SYSTEM

(71) Applicant: TELEFONAKTIEBOLAGET LM ERICSSON(PUBL), Stockholm (SE)

(72) Inventors: Bassant SELIM, LAVAl (CA); EMMANUEL THEPIE FAPI, Cote-Saint-Luc (CA); MANOJ KOPPARAMBIL NAMBIAR, New Westminster (CA); RICHARD OLANIYAN, Montreal (CA); MUTHUCUMARU MAHESWARAN, Pierrefonds (CA)

(73) Assignee: TELEFONAKTIEBOLAGET LM ERICSSON(PUBL), Stockholm (SE)

(21) Appl. No.: 18/277,401

(22) PCT Filed: Feb. 15, 2022
(86) PCT No.: PCT/IB22/51342

§ 371 Date: Aug. 16, 2023

(51) Int. Cl. H04L 67/1095; H04W 24/02

(52) U.S. Cl. CPC H04L 67/1095; H04W 24/02

(57) ABSTRACT

There is provided method for improving distributed training of an artificial intelligence (AI) model in an AI system comprising a plurality of edge servers and a plurality of edge devices. The method comprises synchronizing distributed data acquisition at a plurality of edge devices. The method comprises synchronizing the distributed training of the AI model at the plurality of edge servers, the AI model being trained using the synchronized data acquired from the plurality of edge devices. There is also provided a method executed in an edge device for synchronized data acquisition. There is also provided a method executed in an edge server for synchronized data acquisition. There is also provided a method executed in an edge server for synchronized distributed training of an artificial intelligence (AI) model.

### PRIORITY STATEMENT UNDER 35 U.S.C. S. 119(E) & 37 C.F.R. S. 1.78

This non-provisional patent application claims priority based upon the prior U.S. provisional patent application entitled “EDGE DEVICE, EDGE SERVER AND SYNCHRONIZATION THEREOF FOR IMPROVING DISTRIBUTED TRAINING OF AN ARTIFICIAL INTELLIGENCE (AI) MODEL IN AN AI SYSTEM”, application No. 63/151,335, filed Feb. 19, 2021, in the names of OLINIYAN et al.

### TECHNICAL FIELD

The present disclosure relates to synchronized data acquisition and distributed and federated learning in the context of edge computing.

### BACKGROUND

Tasks synchronization schemes have been proposed where static, dynamic and micro-batch algorithms were developed based on attributes such as arrival pattern, task frequency and execution time variance. Fault tolerant synchronization was also proposed for an edge-controller Internet of Things (IoT) system using component redundancy.

Main drawback of previous approaches is that they are heavily reliant on a controller to achieve synchronization and thus incur extra communication overhead.

Existing synchronization schemes include Bulk Synchronization Parallel (BSP), Stale Synchronization Parallel (SSP), Dynamic Stale Synchronization Parallel (DSSP), and Asynchronous Parallel Model (ASP), which have been proposed for aggregating updates from distributed training nodes.

### SUMMARY

In edge computing paradigm, especially edge-based artificial intelligence (AI) systems, precision of time synchronization is necessary during data acquisition and aggregation, to achieve time-aligned data capture at edge devices (sensing and actuation). Synchronization is also required in distributed and federated machine learning (ML) as the speed of convergence and model accuracy are synchronization scheme dependent (processing).

Synchronization can be considered as a join operation, using time as the reference variable. Since sensor's tasks are often sampled at different rates, a typical join result may result in too much missing data and an inconsistent time step. There is a need for a fast synchronization approach to maximize the quality of the data while maintaining a high rate of capture, to maximize the speed of convergence and accuracy of ML (distributed or federated) model and to coordinate actions by multiple nodes to achieve a common goal.

There is provided reward-based synchronization that minimizes involvement of the controller by making the controller send a proposed synchronized slot to worker nodes and the worker nodes decide whether to synchronize or not depending on the reward, without having to communicate with the controller.

Unlike the SSP (which is an intermediate solution between ASP and BSP) and DSSP, the method proposed herein does not allow any slack in the synchronization process, thus minimizing the impact of stragglers by clustering the worker nodes and eliminating outliers from the process. The method can adapt well to heterogeneous setups where worker nodes execution time can vary for each iteration. With DSSP, worker nodes are expected to have the same or very similar runtimes per iteration.

There is provided a method for improving distributed training of an artificial intelligence (AI) model in an AI system comprising a plurality of edge servers and a plurality of edge devices. The method comprises synchronizing distributed data acquisition at a plurality of edge devices. The method comprises synchronizing the distributed training of the AI model at the plurality of edge servers, the AI model being trained using the synchronized data acquired from the plurality of edge devices.

There is provided a method executed in an edge device for synchronized data acquisition. The method comprises receiving a data acquisition schedule from an edge server, the data acquisition schedule comprising synchronized data acquisition time intervals and guard time intervals. The method comprises scheduling data acquisition within data acquisition time intervals provided in the data acquisition schedule.

There is provided a method executed in an edge server for synchronized data acquisition. The method comprises generating a data acquisition schedule, the data acquisition schedule comprising synchronized data acquisition time intervals and guard time intervals. The method comprises sending the data acquisition schedule to a plurality of edge devices, thereby enabling the edge devices to schedule data acquisition within the data acquisition time intervals provided in the data acquisition schedule.

There is provided a method executed in an edge server for synchronized distributed training of an artificial intelligence (AI) model. The method comprises receiving cluster assignation from a cloud controller. The method comprises receiving, from the cloud controller, a synchronization schedule comprising three synchronization options per iteration for synchronizing the distributed training of the AI model.

There is provided an artificial intelligence (AI) system for improving distributed training of an artificial intelligence (AI) model. The AI system comprises a plurality of edge servers and a plurality of edge devices, each comprising processing circuits and a memory. The memory contains instructions executable by the processing circuits whereby the AI system is operative to synchronize distributed data acquisition at a plurality of edge devices. The AI system is operative to synchronize the distributed training of the AI model at the plurality of edge servers, the AI model being trained using the synchronized data acquired from the plurality of edge devices.

There is provided an edge device for synchronized distributed data acquisition comprising processing circuits and a memory. The memory contains instructions executable by the processing circuits whereby the edge device is operative to receive a data acquisition schedule from an edge server, the data acquisition schedule comprising synchronized data acquisition time intervals and guard time intervals. The edge device is operative to schedule data acquisition within data acquisition time intervals provided in the data acquisition schedule.

There is provided an edge server for synchronized distributed training of an artificial intelligence (AI) model comprising processing circuits and a memory. The memory contains instructions executable by the processing circuits whereby the edge server is operative to generate a data acquisition schedule, the data acquisition schedule comprising synchronized data acquisition time intervals and guard time intervals. The edge server is operative to send the data acquisition schedule to a plurality of edge devices, thereby enabling the edge devices to schedule data acquisition within the data acquisition time intervals provided in the data acquisition schedule.

There is provided an edge server for synchronized distributed training of an artificial intelligence (AI) model comprising processing circuits and a memory. The memory contains instructions executable by the processing circuits whereby the edge server is operative to receive cluster assignation from a cloud controller. The edge server is operative to receive, from the cloud controller, a synchronization schedule comprising three synchronization options per iteration for synchronizing the distributed training of the AI model.

There is provided a non-transitory computer readable media having stored thereon instructions for improving distributed training of an artificial intelligence (AI) model in an AI system. The instructions comprise synchronizing distributed data acquisition at a plurality of edge devices. The instructions comprise synchronizing the distributed training of the AI model at the plurality of edge servers, the AI model being trained using the synchronized data acquired from the plurality of edge devices.

The methods, edge devices and edge servers provided herein present improvements to the way methods, edge devices and edge servers operate.

### BRIEF DESCRIPTION OF THE DRAWINGS

FIGS. 1a and 1b are schematic illustrations of a system in which data capture is performed; and of synchronous and asynchronous data capture.

FIG. 2 is a schematic illustration of Distributed ML (left) application and Federated ML (right) application.

FIG. 3 is a schematic illustration of a typical edge computing architecture with reference node models.

FIG. 4 is a flowchart of a two-stage, L0-Scehduler and L1-Scheduler reward-based synchronization method.

FIGS. 5a and 5b are schematic illustrations of synchronization as a game between clusters.

FIG. 6 is a flowchart of a runtime synchronization method.

FIGS. 7 and 8 are graphs of experimental results.

FIG. 9 is a schematic illustration of a virtualization environment in which the different functions, methods and apparatuses described herein can be deployed.

FIGS. 10 to 13 are flowcharts of methods for improving distributed training of an artificial intelligence (AI) model in an AI system.

### DETAILED DESCRIPTION

Various features will now be described with reference to the drawings to fully convey the scope of the disclosure to those skilled in the art.

Sequences of actions or functions may be used within this disclosure. It should be recognized that some functions or actions, in some contexts, could be performed by specialized circuits, by program instructions being executed by one or more processors, or by a combination of both.

Further, computer readable carrier or carrier wave may contain an appropriate set of computer instructions that would cause a processor to carry out the techniques described herein.

The functions/actions described herein may occur out of the order noted in the sequence of actions or simultaneously. Furthermore, in some illustrations, some blocks, functions or actions may be optional and may or may not be executed: these are generally illustrated with dashed lines.

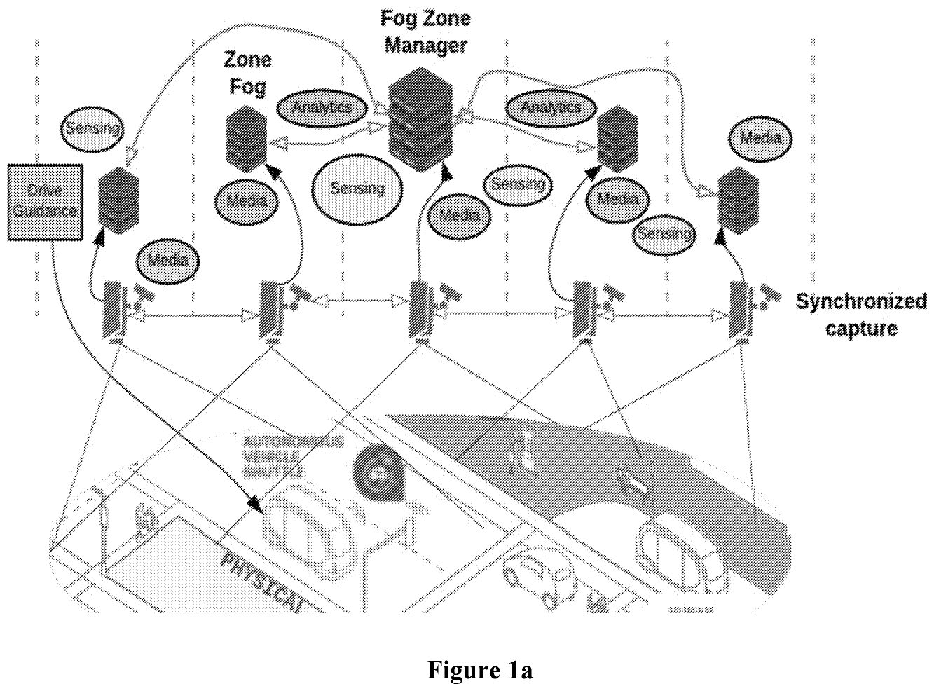

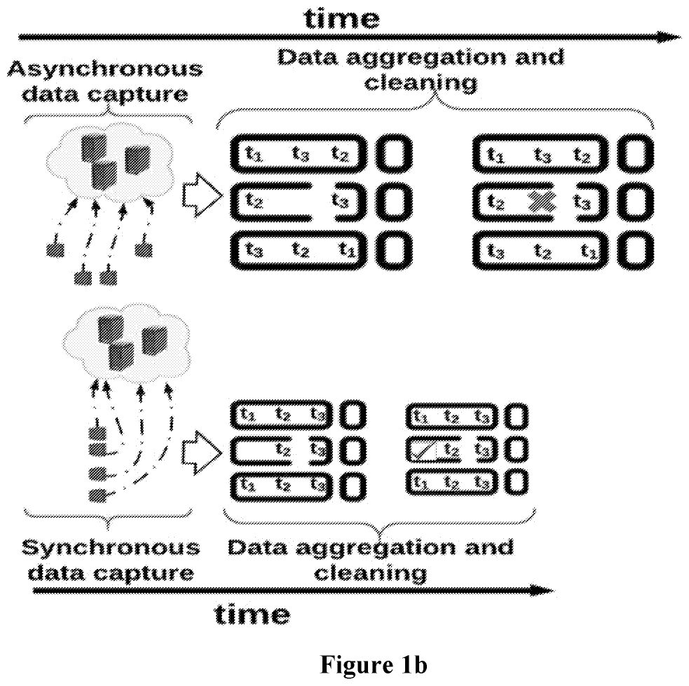

Referring to FIGS. 1a, 1b and 2, two synchronization problems are solved, namely synchronization schemes for time-aligned data capture and coordinated actions (sensing and actuation), FIG. 1, and synchronization schemes to speed up distributed/federated training processes (processing) in edge devices, FIG. 2.

Referring to FIG. 1a, a context of wide area application in a smart city scenario is considered in which an autonomous vehicle (such as a taxi) is deployed using a wide range of applications from the owner's company that run on fog servers installed throughout the smart city. Instead of completely relying on onboard sensors, the autonomous vehicle can use, for example, outside cameras for guidance. Other tasks such as video capture, video processing, drive guidance, sensing, media processing and analytic can be performed outside of the vehicle as well. Some tasks such as video capture and drive guidance have real time constrains while other like media processing is interactive, and analytics have batch processing requirement. All these tasks may be needed for autonomous vehicle operation in such a context and should not occurs at specific time slot. FIG. 1b shows situations where data is aligned in time in synchronous data capture, allowing faster data collation. FIG. 2 also shows data that is not aligned during asynchronous data capture, requiring longer data aggregation and cleaning. FIG. 2 illustrates synchronization impact in processing for Distributed ML (left) application and Federated ML (right) application where model convergence and speed of convergence are dependent.

The reward-based synchronization proposed herein minimizes the involvement of the controller, or controller node e.g., and edge server, in the actual synchronization process by making the controller send a proposed synchronization slot to workers nodes, e.g., IoT devices. Then, the workers nodes decide on whether to synchronize or not depending on the reward, without having to communicate with the controller, thus limiting message overhead or message required in reaching synchronization.

Unlike SSP and DSSP models, the distributed training synchronization proposed herein does not allow any slack in the synchronization process. It does so by creating an optimal number of synchronization points ahead of time based on the previous execution progress of the edge servers. Thus, edge servers do not need to send any messages when a synchronization option fails: they immediately proceed to the next option.

The distributed training synchronization proposed herein can adapt well to heterogeneous setups where worker nodes execution times can vary for each iteration. No slack is allowed in the synchronization process. The impact of stragglers is handled by the clustering of worker nodes and by discarding outliers (stragglers) from the synchronization process. During the training, the message overhead is limited by using clustering and silent message protocol such that overload communications between controller and worker is minimized.

Edge computing along with fifth generation (5G) network has helped bridge the gap left by directly using the cloud in Internet of Things and smart systems. Edge computing offers computing resources closer to the data source at the edge of the network. One of the key advantages of edge computing is to reduce application latency

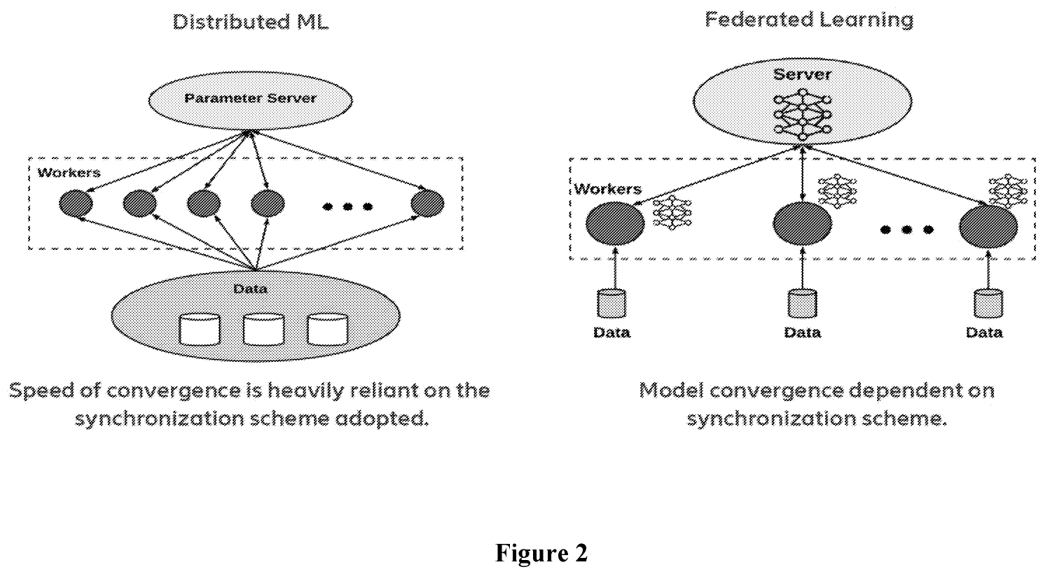

In FIG. 3, a typical edge computing architecture is shown with reference node models, in a three-layer edge on AI architecture consisting of device or sensor layer 301 (devices include, but are not limited to motion sensors, cameras, temperature sensors, mobile phones, smart car, etc.), edge server layer 302 (fog nodes where edge devices are connected via fast 5G network, deployed at base stations or road side units) and cloud layer 303 (at the root of the edge computing architecture offering much more computing and storage capacities).

The system architecture of FIG. 3 involves node model and application model as task types. The edge devices are connected to edge servers (or fog nodes) through fast 5G networks which are capable of communicating with edge devices within their coverage range. Edge servers are deployed at base stations or roadside units, they are equipped with computing units (graphical processing unit or tensor processing units) and storage units. There could be different levels of edge servers depending on proximity and processing power. At the root of the edge computing architecture is the cloud which offers much more computing and storage capacities as well as persistence.

The three-layer edge on AI architecture of FIG. 3 consists of the device (sensor) layer 301, edge server (fog) layer 302 and cloud layer 303. It is assumed that a fast 5G network interconnects all these layers.

1) Sensor Layer 301: The sensor layer consists of several sensor nodes, or devices 305. Both sensing and actuating nodes are part of this layer. Thus, any node that captures or generates data falls under this layer. Sensor nodes are connected to an edge server and can change edge servers when needed. Nodes in this layer could be as small as temperature sensing nodes or as large as high-definition video cameras. Example of nodes that falls under this category include global navigation satellite and inertia measurement sensors for localization, light detection and ranging sensors for mapping, localization and obstacle avoidance, cameras for pedestrian detection, object detection, object tracking, lane detection, and more. Radar and sonar sensors fall under this layer. Synchronization scheme for distributed data capture is developed for nodes under this layer. Some sensor layer nodes are capable of running data compression and data processing algorithms to reduce the volume of data transferred to edge servers over the network.

2) Edge Server Layer 302: This layer consists of a series of interconnected edge servers 310 placed at the edge of the network. Any node capable of receiving and processing data from sensor layer nodes (SLN) are part of this layer. Nodes in this layer are tasked with the job of training and housing AI models, drawing inference from acquired data, as well as providing necessary services to nodes in the sensor layer. Edge servers (ES) 310 are equipped with more computing, storage and processing power capable of dealing with the enormous amount of data generated by 100's or 1000's of sensor nodes 305. Edge servers are responsible of data cleaning and aggregating data from various sensor nodes. ESs are responsible for all the sensor nodes under them. Edge servers can be stationary (e.g., those installed on roadside lamp posts and base stations) or mobile (e.g., installed in an autonomous vehicle).

3) Cloud Layer 303: The cloud layer consists of cloud servers that provide global services such as data storage, complex data processing and big data analysis. The services provided by the cloud are application specific. Edge servers are connected to servers in the cloud layer. The cloud layer orchestrates the distributed training of AI models on edge servers.

Herein, the Application Model consists of three main types of tasks: synchronous tasks, asynchronous tasks and local tasks. Another hybrid task is check point task.

Synchronous and asynchronous tasks are triggered by edge servers on sensor layer nodes (also called worker nodes or workers). A synchronous task is expected to run on at least a desired quorum of SLNs. The SLNs running a synchronous task are required to start the execution of the task at the same point in time. Thus, for synchronous data capture or synchronous actions, the SLNs need to be time aligned before executing the task. Synchronous tasks are blocking tasks and therefore, the edge servers wait for all (or specified quorum of) results before proceeding. An asynchronous task is a non-blocking task where SLNs execute the task using their own schedule. A local task is a task that is triggered by a node on itself. This could range from logging, self-check, to maintenance actions. The check point task is a worker to controller task where workers report back to the controller on their execution progress.

Due to the vast number of nodes in the sensor layer, there is a need to minimize the time spent in aggregation and cleaning of data on edge servers. The reward-based time slotted synchronous scheduling scheme is proposed for that purpose.

Data capture and acquisition is one of the most important aspect of any edge or AI system. It is assumed that the execution space of SLNs is divided into time slots in an iterative manner. Each iteration consists of a mixture of synchronous, asynchronous and local tasks.

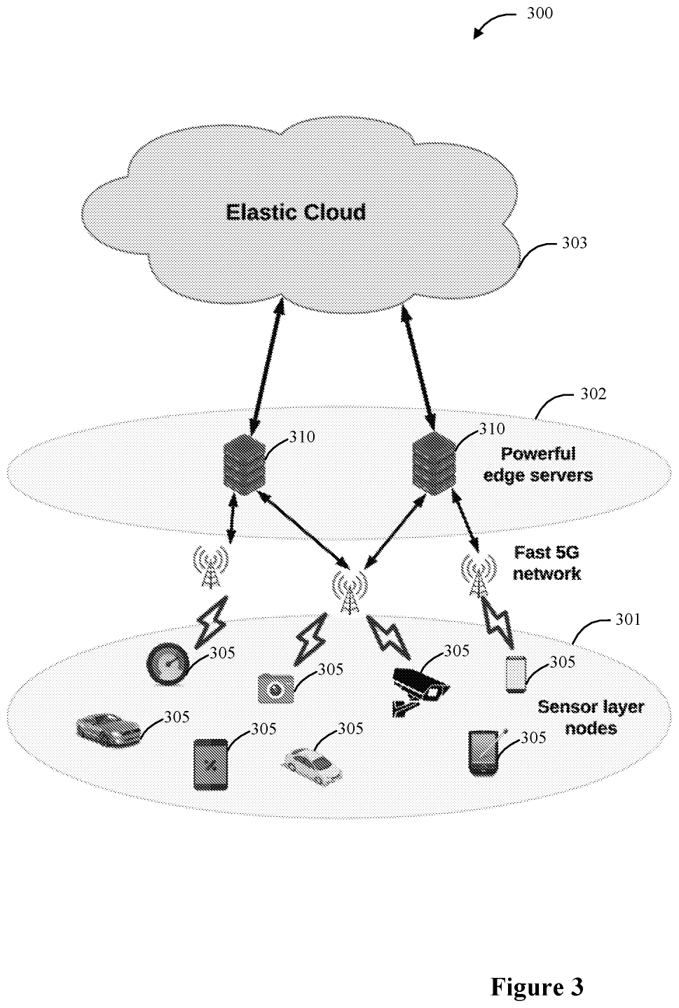

Referring to FIG. 4, an L1-Scheduler 410 is introduced, which resides in the Edge Server 310 also known as controller, the L1-scheduler is used for scheduling time slots for synchronous tasks. The L1-Scheduler then pushes the proposed schedule (slots for sync task with other slots left empty) to the L0-Scheduler 405 on the Sensor Layer Nodes 305. Then the L0-Scheduler, also referenced as worker, schedules the remaining tasks into empty slots in the execution space based on a reward-scheme exploiting synchronization game. L0-Scheduler process to schedule synchronous task in a First-Come-First-Serve (FCFS) approach at the earliest available (empty) slots in the current iteration execution space. Local tasks are scheduled into the remaining slots left or deactivated syn slots using FCFS approach.

FIG. 4 is a flowchart of a two-stage, L0-Scehduler (worker) 405 and L1-Scheduler (controller) 410 reward-based synchronization method. L1-Scheduler generates initial schedule with tentative sync slots and guard slots 420. Guard slot is used by L0-Scheduler for probing L1-Scheduler for the current reward. L0-Scheduler proceeds to schedule asynchronous task in a FCFS approach at earliest available empty slots 425 in the current iteration execution space.

The proposed fast synchronization approach is motivated by three main considerations. Some computations are moved offline: computation such as clustering of workers and pre-generation of schedule of sync tasks and empty slots. There is a reduction of synchronization overhead: the controller involvement is minimized because of clustering. A disconnection tolerant late notification protocol is introduced. Synchronization is achieved as a game between clusters. An optimal number and fixed synchronization options is considered.

### Reward Scheme

Once an application is lunched, L1-Scheduler generates an initial schedule with tentative synchronization (sync) slots and a guard slot. The guard slot is used by the L0-Scheduler (sensor layer nodes) for probing the L1-Scheduler (edge servers) for the current reward 430. Initially, the L1-Scheduler sets the sync reward parameters Rₛ, Rₛ⁰=N×Rₜₕ. The sync reward parameter Rₛ at the edge server is updated based on the number of SLN that synchronized in a previous iteration. Thus, the more SLNs participate in synchronization in a previous round, the higher the reward to be gotten for synchronizing in the next round and vice-versa. Rₛ is split equally amongst all SLNs that synchronized and is defined as:

$${R}_{s}^{j + 1} = {\sum }_{i = 1}^{{N}_{j}} {β}_{i}^{j} \qquad ( 1 )$$

where j is the iteration count, Nⱼ is the number of SLNs that synchronized at iteration j and βᵢ^{j} is a non-negative parameter kept for each SLN calculated based on historical synchronization participation from previous iterations. βᵢ^{j} is initially initialized to Rth. The parameter βᵢ^{j} is increased or decreased by a factor depending on whether SLN i synchronizes at the previous iteration or not as well as how close βᵢ^{j} is to Rth. Let θᵢ be a parameter that is increased by 1 each time SLN i synchronizes and resets back to 0 anytime the SLN does not synchronize. If SLN i does not synchronize at an iteration, the parameter δᵢ is increased by 1 and resets back to 0 whenever SLN i synchronizes.

The parameter βᵢ^{j} can get up to a maximum of 1 and is updated as follows:

$${β}_{i}^{j + 1} = \{ \begin{matrix}{β}_{i}^{j} + ( 0.01 \times {θ}_{i} ) & if SLN i synchronized \\ {β}_{i}^{j} - ( 0.05 \times {δ}_{i} ) & if SLN i unsynchronized\end{matrix} \begin{matrix} \\ \end{matrix} \qquad ( 2 )$$

This means that a SLN is punished at a higher magnitude for not synchronizing than it is rewarded for synchronizing. SLNs that have been involved in synchronization continuously have more impact on reward since they will have larger β values.

If k new SLNs join the system at iteration j, they are activated with a β value equal to the reward threshold Rth to incentivize the SLNs to synchronize. Thus, new SLNs will not have a negative effect on the total system reward. The reward is updated as follows:

$${R}_{s}^{j + 1} = {\sum }_{i = 1}^{{N}_{j}} {β}_{i}^{j} + {\sum }_{z = 1}^{k} {R}_{th} \qquad ( 3 )$$

Whenever the sync reward parameter Rₛ^{j} is less than the reward threshold Rth, an external stimulus θ is applied to the reward parameter to incentivize the SLNs to synchronize. The new sync reward parameter becomes Rₛ^{j}=Θ×Rₛ^{j}.

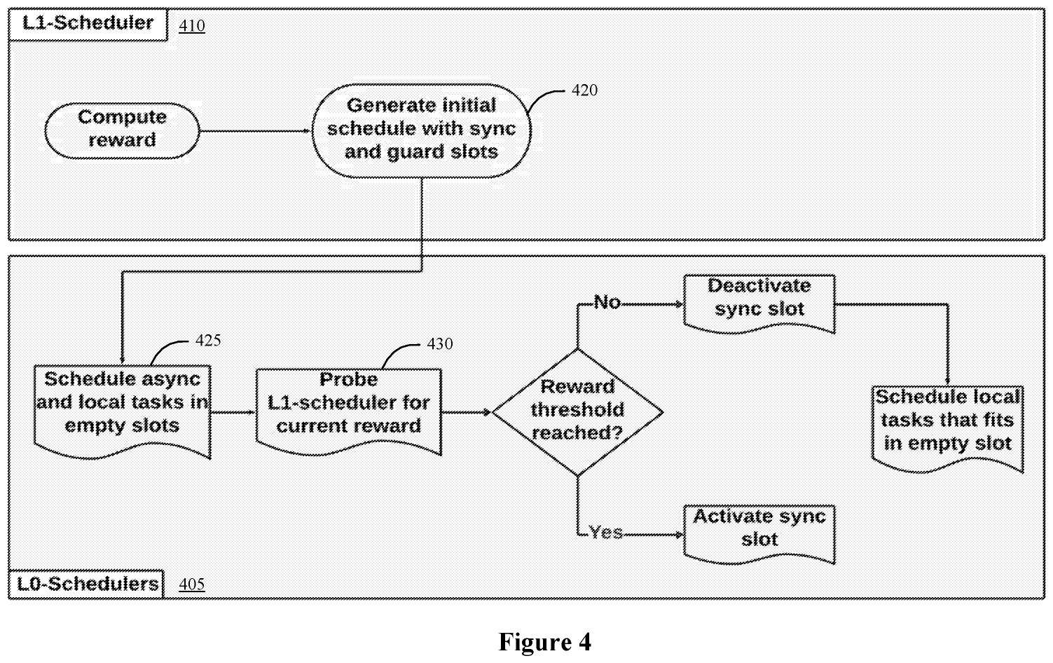

Fast Synchronization approach using game theory is deployed at Sensor Layer Nodes. To achieve this fast synchronization, workers are grouped into two major cluster to reduce message overhead and the game leverages communication among workers. The game is played between the two major clusters (outliers are ignored). Payoff are fixed such that earlier sync options have higher payoff. The cluster makes choices that look to maximize the cumulative payoff. Synchronization options are fixed. Workers know what to do for all runtime scenarios without need for extra message. FIGS. 5a and 5b illustrate the first pass of synchronization game, with different processing steps.

The synchronization as a game is deployed at sensor layer nodes between clusters. Communication overhead is between clusters, and it is achieved by a game played between the major 2 clusters while ignoring outliers. Synchronization options are known and fixed and used to form a payoff matrix. All workers know what to do for all runtime scenarios without needing extra messages.

### Two-Stage Synchronous Scheduling Algorithm

The two-stage synchronous scheduling algorithm 1 consists of schedulers at two layers. The L1-schedulers at the edge servers iteratively generate schedules with only sync slots and guard slots and send the schedules to the sensor layer nodes under them. The L0-schedulers at SLNs then schedule other tasks (asynchronous and local) into empty execution slots as shown in Algorithm 1. It is assumed that in a single iteration, all remote tasks (sync and async) are scheduled to run in that iteration. However, local tasks from one iteration need not be scheduled in that iteration. Thus, the local task queue can contain tasks from previous iterations. It is also assumed that there will be one sync task per iteration and only sync tasks have deadlines.

The L1-scheduler at each iteration updates the β values for each SLN and recalculates the reward Rₛ^{j} using Equation 3.

The L1-scheduler monitors the roundtrip time (RTT) for each SLN and keeps an updated averaged value after each iteration. The RTT is measured every time the SLNs run the guard task.

The guard task T_{guard} is scheduled to start at time t_{guard} which is computed by subtracting the RTT (sent by the L1-scheduler) from the synchronous task start time tₛₜₐᵣₜ(Ts). This ensures that the SLNs get the result of probing the edge server for the updated reward back to the SLN in order to decide whether or not to activate or deactivate the tentative sync slot (Lines 25-29 of Algorithm 1). The sync task start time tₛₜₐᵣₜ(Ts) is computed by subtracting the task execution time and a parameter γ from the task deadline as shown on line 15 of Algorithm 1. The parameter γ is used as a tuning value to accommodate local tasks in case a sync slot is deactivated. The L1-scheduler sends this partial schedule with sync, guard and empty slots to all SLNs connected to it.

The L0-scheduler proceeds to schedule asynchronous tasks in a first-come-first-serve (FCFS) approach at the earliest available (empty) slots in the current iteration execution space. Local tasks are scheduled into the remaining slots left or deactivated sync slots using the FCFS approach.

Algorithm 1: Two-stage synchronous scheduling algorithm

| | |
|---|---|
| 1 | Input: Set of tasks (synchronous, asynchronous and local |
| | tasks) and their deadlines. |
| 2 | Output: Schedule of tasks. |
| 3 | Params: Round trip time, RTT = 0 |
| 4 | tₑₓ(Tᵢ) = runtime of task Tᵢ |
| 5 | t_{dl}(Tᵢ) = deadline for task Tᵢ |
| 6 | Rₛ^{j} = total sync reward at iteration j |
| 7 | tₛₜₐᵣₜ(Tₛ) = sync slot start time |
| 8 | Rₜₕ = sync reward threshold per SLN |
| 9 | α = required quorum of SLNs |
| 10 | L1-scheduler (iteration j + 1): |
| 11 | compute RTT_{new} = Σ_{z=1}^{N}^{ⱼ} RTT_{z} |
| 12 | set RTT = RTT_{new} |
| 13 | update R^{j} using Equation [symbol] |
| 14 | compute tₛₜₐᵣₜ(Tₛ) = t_{dl}(Tₛ) − tₑₓ(Tₛ) − γ |
| 15 | compute t_{guard} = tₛₜₐᵣₜ(Tₛ) − RTT |
| 16 | schedule(T_{guard}, t_{guard}) |
| 17 | schedule(Tₛ, tₛₜₐᵣₜ(Tₛ)) |
| 18 | send schedule to L0-schedulers |
| 10 | L0-scheduler (iteration j + 1); |
| 20 | for (task Tₐ in asynchronous task queue): |
| 21 | schedule(Tₐ, tₐᵥₐᵢₗ) |
| 22 | schedule local tasks in empty slots in first-come-first-serve |
| | order |
| 23 | During runtime: |
| 24 | check(reward): |
| 25 | $if \frac{{R}_{s}^{j}}{{N}_{j + 1}} \geq {R}_{th} :$ |
| 26 | activate sync slot |
| 27 | else: |
| 28 | deactivate sync slot |
| 29 | apply external stimulus to reward |
| 30 | schedule remaining local tasks in deactivated sync slot in |
| | first-come-first-serve order |

### Synchronized Distributed/Federated Training

Training and running AI models at the edge is necessary for extracting intelligence from data acquired and cleaned from sensor layer nodes. Training AI models at the edge is done in distributed or federated manner such that there is no need for data transfer over the network. The reference Distributed Neural Network (DNN) or Federated Neural Network (FNN) model parameters resident in the cloud are updated iteratively by the edge servers. Synchronizing the update enables achieving higher accuracy and faster convergence of the neural network models.

The synchronized distributed training achieves fast convergence of AI model training in edge servers by minimizing the number of messages required in reaching synchronization and limiting the cloud's involvement. One of the ways this is achieved is by the use a silent communication protocol whereby edge servers proceed to synchronize if they do not receive any notifications. Clustering and a late notification protocol are used to achieve a fast synchronization rate. The clustering is done such that edge servers with higher probability of staying tightly synchronized within some bounds are grouped into a logical cluster.

### Edge Clustering

The edge servers are clustered for these two reasons: (i) to minimize the communication overhead incurred in reaching synchronization, and (ii) to help the cloud (controller) in making better scheduling decisions. The cloud uses execution progress report from edge servers to cluster the edge servers. The edge servers iteratively report their execution progress to the cloud by running a progress-tracker task that is pre-scheduled. All the edge servers in a particular cluster are expected to remain tightly synchronized and make the same synchronization decisions. Re-clustering is triggered whenever the quality of synchronization reduces beyond a certain threshold. In this synchronization scheme, a two-cluster system is considered, where edge servers belong to either of the two logical clusters or they can be classified as outliers.

### Disconnection-Tolerant Late Notification Protocol (DTLNP)

Due to heterogeneous nature and high uncertainties in AI on edge systems, some nodes are expected to have delays, faults, failures or crashes. These actions can cause a node or couple of nodes within a cluster to deviate from tightly synchronizing with the other members of the cluster. Thus, making synchronization decisions different from the cluster. To deal with this issue, a disconnection-tolerant late notification protocol was developed to make the synchronization scheme fault and disconnection tolerant.

At a synchronization point, edge servers are expected to proceed with synchronization at the scheduled time if they do not receive any late notifications. Late notifications are expected to be representative of a cluster, thus, when an edge server broadcasts a late notification, it is representative of the cluster to which it is a member. To reduce the number of messages involved in reporting and detecting lateness, a bound is defined on the number of late notification messages that can be sent from edge servers within a cluster regardless of the number of edge servers in the cluster.

The protocol allows a maximum of three messages per cluster to indicate that the cluster will be late. It is assumed that edge servers can detect if they will be late to the synchronization point before getting to the point based on previous iterations and the predicted cluster finish time for the previous task. The first edge server in a cluster that detects it will be late broadcasts a late notification to all edge servers. After the first notification, the probability of sending further late notifications is set to:

$${P}_{late} = \frac{2}{N - 1} \qquad ( 4 )$$

Thus, if all the workers in a cluster are late, a total of 3 notifications is expected.

Edge servers can get stuck at a synchronization point if they do not receive late notification messages that were broadcasted due to network partitioning. The edge server could be temporarily or permanently isolated from the rest of the system. An edge server that is temporarily isolated is only disconnected for one or a few iterations while a permanently isolated edge server is totally disconnected from other edge servers in the system.

To ensure safety and to prevent an edge server from getting stuck due to temporary isolation, previous late notifications are embedded in new late notifications. Thus, the later late notification will contain details of the previous late notification. If the previous late notification gets lost due to network partitioning, the edge servers will get both late notifications embedded in the later notification. An edge server that is completely isolated will continue executing tasks in isolation until it gets connected back.

### Mixture Distributions

The cloud tracks the progress of edge servers using checkpoints defined in the application. The cloud creates two distributions for the expected finish time of the task before the synchronization point for each cluster in the system using the previous reported runs and progress of edge servers in the clusters. Each cluster is represented by a mixture of two Gaussian distributions. The first distribution, [symbol] ₑ(μₑ, σₑ²) represents the early execution times distribution of a cluster while the second distribution, [symbol] ₗ(μₗ, σₗ²) represents the late execution times distribution of a cluster. It is assumed that the distribution of the execution times of local tasks on edge servers in both clusters is learned. The distribution is a mixture of models and defined as [symbol] ₑ^{lo}(μₗₒₑ, σₗₒₑ²) and [symbol] ₗ^{lo}(μₗₒ_{ₗ}, σₗₒ_{ₗ}²).

Given the mixture distribution for both clusters and the distribution of the execution time of local tasks, the expected available times of the clusters can be computed from the mixture distributions by choosing a desired percentile p(x). The percentile values are used because edge servers in a cluster are expected to make similar decisions. It is important to note that the sum Z of two normally distributed independent random variables X˜ [symbol] (μₓ, σₓ²) and Y˜ [symbol] (μ_{y}, σ_{y}²) is also normally distributed, Z˜ [symbol] (μₓ+μ_{y}, σₓ²+σ_{y}²).

### Optimal Synchronization Options

The synchronization scheme aims to achieve faster synchronization rate by minimizing communication overhead in reaching synchronization. To use silent communication protocol multiple synchronization options should be available in case one fails. This ensures that edge servers do not need to send/receive any messages in case an option fails, the edge servers proceed to synchronize at the next synchronization option. To avoid indefinitely waiting and retrying synchronization, there should be a bounded number of synchronization options per synchronization point.

Below are definitions used in deciding the optimal number of synchronization options or retries.

Definition 1: The reward derived from synchronizing at an earlier synchronization option and point in time is much greater than the reward for a later option regardless of any added reward (reward from running a local task).

Definition 2: The penalty for aborting synchronization increases downwards from the first sync option to the last sync option.

Definition 3: A cluster that decides to synchronize at an option knows that the other cluster has no incentive to abort synchronization.

Definition 4: A cluster by itself is not enough to form a quorum to proceed with synchronization.

The clusters get the highest reward when they both decide to synchronize at the first option. This means that no late notification was broadcasted from either cluster. Suppose there are two clusters, C_{fa} and Cₛₗ, approaching a synchronization point, where C_{fa} is the faster cluster in terms of execution speed and Cₛₗ is the slower cluster. To determine the optimal number of synchronization options, different scenarios are considered. The first option will be to attempt synchronization at the earliest point in time where it is expected to have the desired quorum of edge servers available based on the mixture distributions. The first synchronization option does looks to minimize the overall waiting time (penalty) in both clusters.

If the slower cluster detects it is going to be late to the first synchronization option, there is a need for a second option.

This option is fixed such that if the faster cluster executes a local task upon receiving a late notification from the slower cluster, it does not cause the slower cluster to wait. Thus, the second option is fixed to maximize the reward of the faster cluster executing a local task minus the penalty incurred by the slower cluster in further waiting. This guarantees that the cumulative reward for both clusters is maximized.

In the case where the faster cluster C_{fa} ends up executing a local task but overshoots the second synchronization option, it informs the slower cluster Cₛₗ since it has no incentive not to do so according to Definition 3. The second cluster can in turn run a local task with the aim of maximizing the cumulative reward. The third synchronization option is thus fixed to the maximum reward of Cₛₗ executing a local task minus the penalty incurred by C_{fa} in further waiting after becoming available. Beyond this point, there is no option that guarantees an optimal solution can be found since both clusters would have executed local tasks and there is no other way to improve on the cumulative reward.

There are therefore three optimal synchronization options depending on the actions of the clusters. In the case where a cluster is unable to make the first synchronization option, the next optimal solution is for the other cluster to attempt running a local task if available and go to the second synchronization option. A cluster will wait for synchronization if it expects its local task to overshoot the sync option since this will maximize the cumulative reward. In order to maximize the reward gotten from synchronizing, the sync options are fixed such that the expected number of edge servers can form a quorum. Synchronization is attempted at the earliest possible options.

### Fixing the Synchronization Options

First Synchronization Option: The first sync option is fixed at a time tₛ¹ such that the desired quorum is met by choosing a certain percentile p(x) on the early distributions [symbol] ₑ^{fa} and [symbol] ₑ^{sl} of the faster and slower clusters. The early execution distributions are used in order to fix the first synchronization option as early as possible. Let t₁^{fa} and t₁^{sl} be the time values that correspond to the chosen percentiles on the early distributions for both clusters. The time tₛ¹ for the first synchronization option is fixed by solving the following equation:

$${t}_{1}^{fa} = p ( x ) \{ {𝔾}_{e}^{fa} \} \qquad ( 5 )$$

$${t}_{1}^{s l} = p ( x ) \{ {𝔾}_{e}^{s l} \}$$

$${t}_{s}^{1} = max ( {t}_{1}^{fa} , {t}_{1}^{s l} )$$

$$s . t . p ( x 1 ) \vert {C}_{fa} \vert + p ( x 2 ) \vert {C}_{s l} \vert \geq α N$$

Second Synchronization Option: The second sync option is fixed such that the faster cluster C_{fa} either waits for the slower cluster Cₛₗ (which is late) or executes a local task (if available) if it increases the cumulative reward (i.e., reward for executing local task by faster cluster R_{local}^{fa} is greater than the penalty or cost of waiting by the slower cluster C_{wait}^{sl}). The percentile for the expected available time is drawn from the late distribution of the slower cluster. The second sync option tₛ² is fixed by solving the equation:

$$\begin{matrix}{t}_{2}^{fa} = {t}_{1}^{fa} & if {R}_{local}^{fa} < {C}_{wait}^{sl}\end{matrix} \qquad ( 6 )$$

$${t}_{2}^{fa} = {t}_{1}^{fa} + p ( x {1}^{′} ) \{ {𝔾}_{e}^{fa} + {𝔾}_{e}^{lo} \} \qquad if {R}_{local}^{fa} \geq {C}_{wait}^{sl}$$

$${t}_{2}^{sl} = p ( x {2}^{′} ) \{ {𝔾}_{l}^{sl} \}$$

$${t}_{s}^{2} = max ( {t}_{2}^{fa} , {t}_{2}^{sl} )$$

$$s . t . p ( x {1}^{′} ) \vert {C}_{fa} \vert + p ( x {2}^{′} ) \vert {C}_{s l} \vert \geq αN$$

t₂^{fa} is the time point where a desired percentile of the workers in the faster cluster is expected to be available to synchronize. If cluster C_{fa} executes a local task, t₂^{fa} is gotten by getting the desired percentile from the sum of the distributions [symbol] ₑ^{fa} and [symbol] ₑ^{lo}.

Third Synchronization Option: The last synchronization option is fixed to cater for the situation where the cluster (C_{fa}) running the local task is late for the second sync option and sends a late notification to cluster Cₛₗ. Cluster Cₛₗ can decide to wait or run a local task. This is dependent on which of the choices increases the cumulative reward. The new expected available time of C_{fa} is drawn from the sum of the distributions [symbol] ₑ^{fa}+ [symbol] ₗ^{lo}·tₛ³ is fixed by solving:

$${t}_{3}^{fa} = {t}_{2}^{fa} + p ( x {1}^{″} ) \{ {𝔾}_{e}^{fa} + {𝔾}_{l}^{lo} \} \qquad ( 7 )$$

$${t}_{3}^{sl} = {t}_{2}^{sl} \qquad if {R}_{l ocal}^{sl} < {C}_{wait}^{fa}$$

$${t}_{3}^{sl} = {t}_{2}^{sl} + p ( x {2}^{″} ) \{ {𝔾}_{l}^{s l} + {𝔾}_{e}^{l o} \} \qquad if {R}_{local}^{sl} \geq {C}_{wait}^{fa}$$

$${t}_{s}^{3} = max ( {t}_{3}^{fa} , {t}_{3}^{sl} )$$

$$s . t . p ( x {1}^{″} ) \vert {C}_{fa} \vert + p ( x {2}^{″} ) \vert {C}_{sl} \vert \geq αN$$

t₃^{fa} is the time point where a desired percentile of the workers in the faster cluster are expected to have finished executing the local task. There is a switch to the late local task execution distribution [symbol] ₗ^{lo} since the cluster is late. X₁″ is drawn from the sum of the distributions { [symbol] ₑ^{fa}+ [symbol] ₗ^{lo}}. If cluster Cₛₗ executes a local task, t₃^{si} is drawn from the sum of the distributions { [symbol] ₗ^{sl}+ [symbol] ₑ^{lo}}.

### Synchronization Algorithm

The synchronization algorithm shows the synchronization process and decisions made by the cloud and the edge servers as shown in Algorithm 2. In distributed training, the two main operations are computing gradients (done by edge servers asynchronously) and parameter update (done at the cloud synchronously). Thus, the two tasks at the edge servers, per iteration, are the asynchronous task of computing gradients and the synchronous task of updating parameters at the cloud. There could also be local tasks that involve actions triggered by an edge server on itself. These actions could be logging, configuration, data cleaning tasks and so on.

Algorithm 2: Synchronized
distributed training algorithm

| | |
|---|---|
| 1 | Cloud |
| 2 | forEach synchronization point do: |
| 3 | Fix the three sync options tₛ¹, tₛ² and tₛ³ by solving |
| | Equations [symbol] , [symbol] and [symbol] respectively |
| 4 | Edge Servers |
| 5 | forall Edge Servers do: |
| 6 | First sync option: |
| 7 | if (tₐᵥ^{fa} ≤ t₁^{fa}) and (tₐᵥ^{sl} ≤ t₁^{sl}) [symbol] |
| 8 | execute(T_{sync}, tₛ¹); |
| 9 | elif (tₐᵥ^{fa} ≤ t₁^{fa}) and (tₐᵥ^{sl} > t₁^{sl}) and late_notify: |
| 10 | if tₗ¹ ≤ tₛ¹ − tₐᵥ^{fa}: |
| 11 | execute(T_{local}, tₐᵥ^{fa}) [symbol] |
| 12 | proceed to second sync option [symbol] |
| 13 | elif (tₐᵥ^{fa} > t₁^{fa}) and (tₐᵥ^{sl} > t₁^{sl}) [symbol] |
| 14 | proceed to second sync option; |
| 15 | elif (tₐᵥ^{fa} ≤ t₁^{fa}) and (tₐᵥ^{sl} > t₁^{sl}) and no_late notify: |
| 16 | abort(sync); |
| 17 | Second sync option: |
| 18 | if (t_{av′}^{fa} ≤ t₂^{fa}) and (t_{av′}^{sl} ≤ t₂^{sl}) [symbol] |
| 19 | execute(T_{sync}, tₛ² [symbol] |
| 20 | elif (t_{av′}^{fa} > t₂^{fa}) and (t_{av′}^{sl} ≤ t₂^{sl}) and late_notify: |
| 21 | if tₗ² ≤ tₛ² − tₐᵥ^{sl} [symbol] |
| 22 | execute(T_{local}, tₐᵥ^{sl}); |
| 23 | proceed to line; |
| 24 | elif (tₐᵥ^{fa} ≤ t₁^{fa}) and (tₐᵥ^{sl} > t₂^{sl}) and no_late_notify: |
| 25 | abort(sync); |
| 26 | Third sync option: |
| 27 | if (tₐᵥ [symbol] ^{fa} ≤ t₃^{fa}) and (tₐᵥ [symbol] ^{sl} ≤ t₃ [symbol] ^{l}) [symbol] |
| 28 | execute(T_{sync}, tₛ³); |
| 29 | elif (tₐᵥ [symbol] ^{fa} ≤ t₃^{fa}) and (tₐᵥ [symbol] ^{sl} > t₃ [symbol] ^{l}) [symbol] |
| 30 | abort(sync); |

[symbol]

indicates data missing or illegible when filed

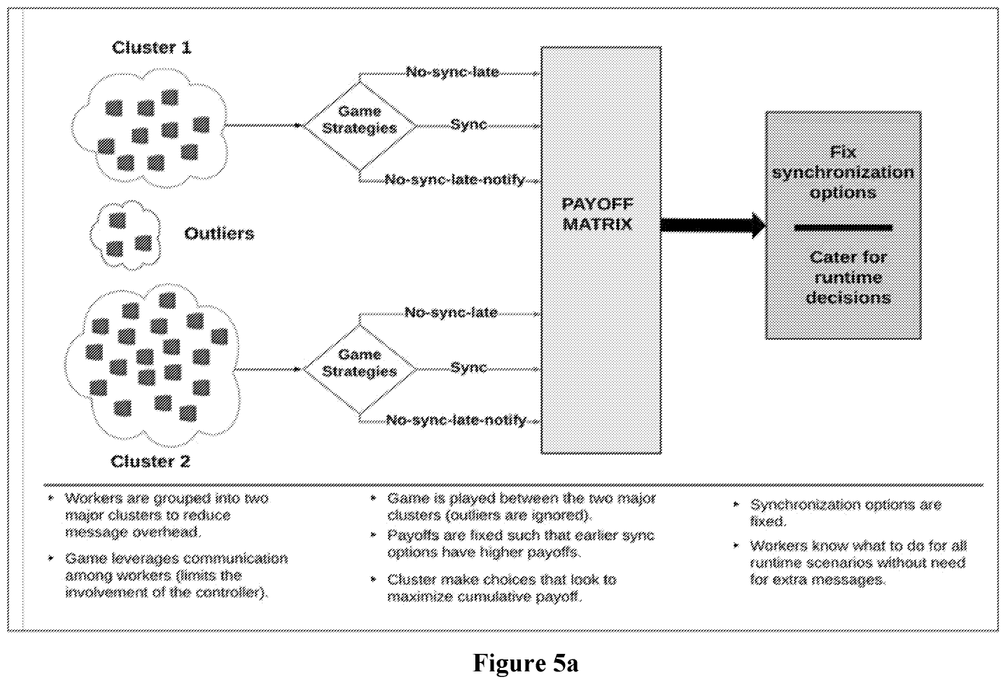

The algorithm outputs the different runtime actions that can be taken by the clusters depending on the runtime configurations. The available times of fast and slow clusters C_{fa} and Cₛₗ are tₐᵥ^{fa} and tₐᵥ^{sl}, respectively. The synchronization runtime flow is shown in FIG. 6. The cloud (controller) computes the synchronization schedule 605 and fixes the three synchronization options for each synchronization point by solving Equations 5-7. Asynchronous tasks are run as soon as the edge servers become available 610.

As shown in FIG. 6, the synchronization process and decisions made by the cloud and the edge servers depend on the runtime configurations. The cloud computes schedule creates clusters and generate distributions 615. Edge servers execute tasks based on schedule and report execution progress to controller or cloud.

Referring to Algorithm 2, for the first sync option for the edge servers, if both clusters become available before the predicted available times (Line 7), the sync task is executed at the first sync option (Line 8). However, if the slower cluster is late and sends a late notification to the faster cluster, the faster cluster can run a local task before proceeding to the second option if the local task can fit in the space (Lines 9-11). If both clusters are late to the first sync option, they both proceed to the second sync point. Synchronization is aborted whenever a late cluster does not send a late notification, synchronization is aborted (Lines 15-16 and 24-25).

At the second sync option, the same operations apply as in the first sync option. However, if the faster cluster is late in executing the local task, the slower cluster can likewise decide to execute a local task before proceeding to the third sync option, if it can fit, (Lines 20-22). The sync task is executed at the third sync option only if both clusters are available at the predicted available times. Else, synchronization is aborted, and that particular synchronization point is considered to have failed.

### Experiments and Results

### Synchronized Data Capture

Configuration of Synchronization Experiments: the following configurations are used to define the application and system parameters. To explore deeply into many aspects of the proposed reward based two-stage synchronization algorithm, a wide range of parameter variations is used. The parameters used in the simulations are as follows. (i) Failure rate: the probability of a SLN failing at a particular iteration. (ii) Reward threshold: the minimum reward a SLN must get before it activates a synchronization slot. (iii) Repair rate: the probability of a failed SLN getting repaired and rejoining the system in an iteration. (iv) Join rate: the probability of a SLN joining at the start of a new iteration. (v) SLN runtime variation: the execution time variation among SLNs for the same task.

Default Parameter Values and Measurements: The number of independent runs of each simulation is set at 200 and each task graph is run continuously for 500 iterations. Task graphs consists of between four to seven asynchronous tasks, one synchronous task and between one and three local tasks determined randomly. The runtime of each task in the task graph is generated using a Gaussian distribution with a mean of 100 ms and a standard deviation of 5 ms. Five different variations of task graphs are used in the simulation runs. Heterogeneity is introduced among SLNs by varying the execution time of a task among them using a Gaussian distribution. The probability of a new SLN joining at the start of an iteration is set at 0:1. The failure rate of SLNs is set at 0:1 and the repair rate set at 0:5 except otherwise stated. The reward threshold Rth is set at 0:5 and the external stimulus θ is set at 1:5.

The following parameters are measured in the simulations. (i) Successful sync tasks: the total number of times where synchronization among SLNs was successful. (ii) Utilization: the average percentage of time when an SLN was busy executing tasks.

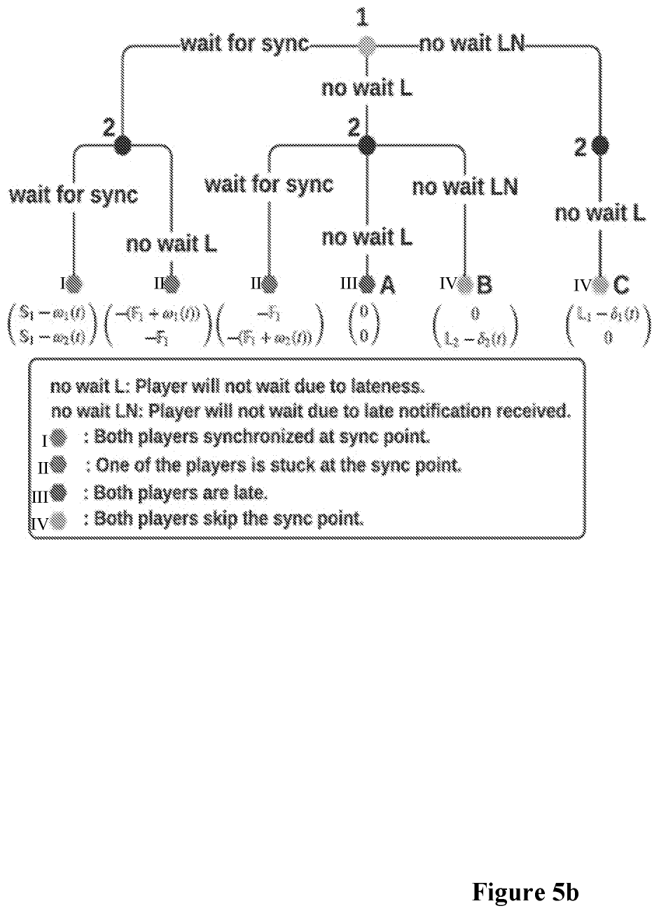

Results: the SLN failure rate is varied from 5% to 30% to explore the impact of SLN failures on the reward-based synchronization scheme. FIGS. 7 a to d show that the number of successful synchronizations decreases as the failure rate increases. The number of successful synchronizations decreases as the failure rate increases as shown in FIG. 7a, which illustrates the number of successful synchronizations (out of 200) for varying SLN failure rates. The average number of successful synchronizations decreased by half from 196 to about 98 when the failure probability increased from 5% to 30%. Increasing the failure rate has an increasingly negative effect on the number of successful synchronization points. FIG. 7b shows the SLN utilization across SLNs for different SLN failure rates. The average utilization decreases as the failure rate increases. This is because at higher failure rates, there are more failed synchronizations and SLNs have to deactivate the sync slots. Thus, some SLNs become idle at the sync slot if they do not have local tasks to execute at the deactivated sync slots. The utilization reduces at a lower rate compared to the successful synchronizations, because during failed synchronization iterations, SLNs can execute pending local tasks in those slots. To measure the impact of SLN heterogeneity on the synchronization algorithm, a Gaussian distribution is used to depict the runtime of tasks on SLNs. The variance of the distribution is varied from 0 to 20 ms, with 20 ms indicating a very high level of heterogeneity. FIG. 7c illustrates the number of successful synchronizations (out of 200) for varying SLN execution times for the same task. The number of successful synchronizations decrease as the as SLN heterogeneity increases as shown in FIG. 7c. There is an average of 95% sync success rate when there is no SLN heterogeneity (0 variance), hence, sync failures are only due to network partitions. With 20 ms variance, the sync success rate dropped to 50%.

The number of SLNs is varied from 5 to 500 to explore the scalability of the algorithm. Increasing the number of SLNs causes an increase in the number of successful synchronizations as seen in FIG. 7d. FIG. 7d illustrates the number of successful synchronizations (out of 200) for varying number of SLNs. With 5 SLNs, there was an average of 79% synchronization success rate. The average synchronization success rate increased to 91% when the number of SLNs is increased to 500. This is because the impact of some SLNs failing and not synchronization is less when there are more SLNs in the system.

### Synchronized Distributed Training

A deep residual neural network model is trained, ResNet20 with 20 layers and 270,000 parameters on the CINIC-10 classification dataset with 1000 classes in batches of 128. The dataset contains images from CIFAR-10 (https://www.cs.toronto.edu/˜kriz/cifar.html) and ImageNet database images (http://image-net.org/download-images) which is split into three parts (train, validation and test) each with 90,000 images. The training and validation dataset are combined in the experiments for training and the test dataset is used for evaluating the accuracy the model.

The ResNet20 model is trained on both a homogeneous and heterogeneous cluster on Amazon Web Services (AWS) EC2. The homogeneous cluster consists of 3 g4dn.4xlarge instance types each with 1 GPU, 16 virtual CPUs, 65 GB RAM and a network of up to 25 Gigabit. The heterogeneous cluster is used to depict the case where edge servers have varying computing, processing and network capabilities. Thus, some edge servers are expected to be the faster than others. The heterogeneous cluster consists of three AWS EC2 instance types: g4dn.4xlarge (1 GPU, 16 virtual CPUs, 65 GB RAM and a network of up to 25 Gigabit), g4dn.2xlarge (1 GPU, 8 virtual CPUs, 32 GB RAM and a network of up to 25 Gigabit) and g3s.xlarge (1 GPU, 4 virtual CPUs, 31 GB RAM and a network of up to 10 Gigabit). The density-based spatial clustering of applications with noise (DBSCAN) is used with a clustering algorithm to group edge servers into clusters. DBSCAN groups together points that are close to each other based on a distance measurement (usually Euclidean distance) and a minimum number of points. It also marks as outliers the points that are in low-density regions.

The performance of the algorithm is evaluated by comparing its performance against the ASP, BSP and SSP (with different staleness threshold) parameter server models. All the frameworks including the synchronized distributed training algorithm are implemented in Ray3: a Python framework for developing distributed applications. The training times, training iterations and training accuracy are measured for all models for different runtime configurations.

FIG. 7e shows the number of training iterations required to reach a 70% training accuracy for varying number of homogenous SLNs using the trained ResNet20 model. The experiments are run for varying number of edge servers. BSP requires the least number of training iterations for all sets of edge servers as shown in FIG. 7e, but each iteration for BSP takes much longer as shown in FIG. 7f, which illustrates the amount of time required to reach 70% training accuracy for varying number of homogenous SLNs. This is because BSP uses a barrier and all updates from edge servers must be applied at parameter server before the edge servers proceed to the next iteration. The SSP variations with staleness values of 3: SSP3 and 5: SSP5 require less training iterations and times to reach 70% training accuracy compared to the ASP implementation for the homogeneous cluster setup. The algorithm spends the least amount of iterations and time in reaching 70% accuracy for varying number of edge servers. The time to reach 70% accuracy decreases as the number of edge servers increase. This is because more batches are trained when there are more edge servers.

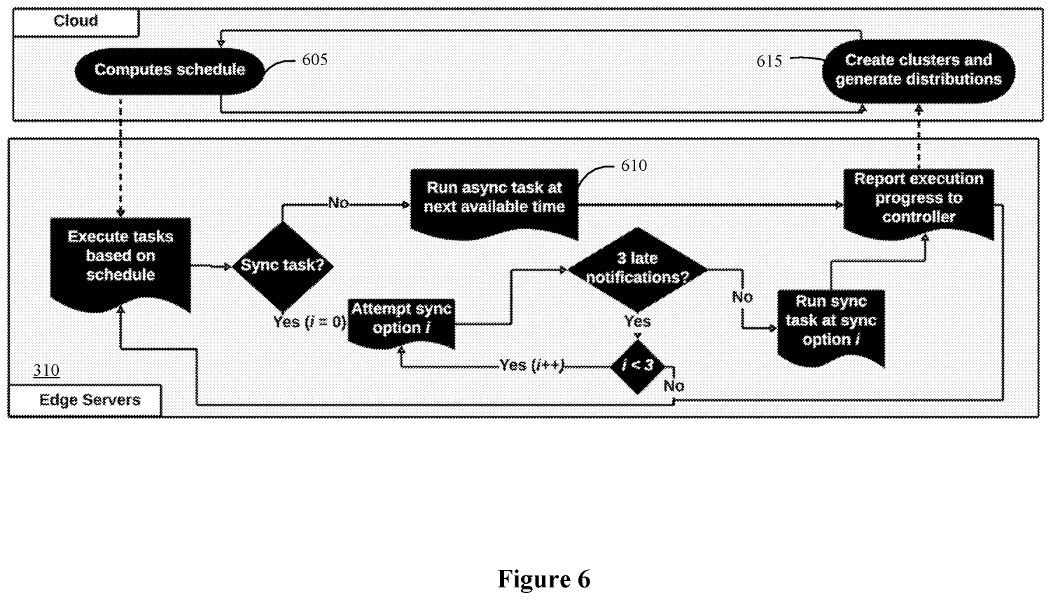

To explore the effect of heterogeneity and to introduce some stragglers among the edge servers, the ResNet20 model is trained in both the homogeneous and heterogeneous setup. The training time to reach 70% accuracy is shown in FIGS. 7f and 8a for the homogeneous and heterogeneous cluster setup respectively. FIG. 8a illustrates the amount of time required to reach 70% training accuracy for varying number of heterogenous SLNs. The training time to reach 70% training accuracy increased for all frameworks, with ASP being less impacted with an average training time increase of 8% closely followed by the algorithm described herein with a 12% increase in training time. BSP was most impacted with an increase of 22% followed by SSP3 and SSP5 respectively.

Finally, FIGS. 8b and 8c show the measure of the training accuracy vs training time for 8 edge servers for both the homogeneous (FIG. 8b) and heterogeneous (FIG. 8c) cluster setups. BSP reaches 45% accuracy faster than other frameworks for the homogeneous cluster setup at 200 s training time. Beyond this point, all other frameworks reach high training accuracy compared to BSP. The algorithm presented herein performs as well as ASP for earlier training times and as well as the SSP implementations for later training times. For the heterogeneous cluster setup, the algorithm proposed herein achieves an accuracy higher or as good as SSP and ASP for all training times. This is because the algorithm uses clustering to group edge servers together and the communication among edge servers is greatly reduced compared to the other models.

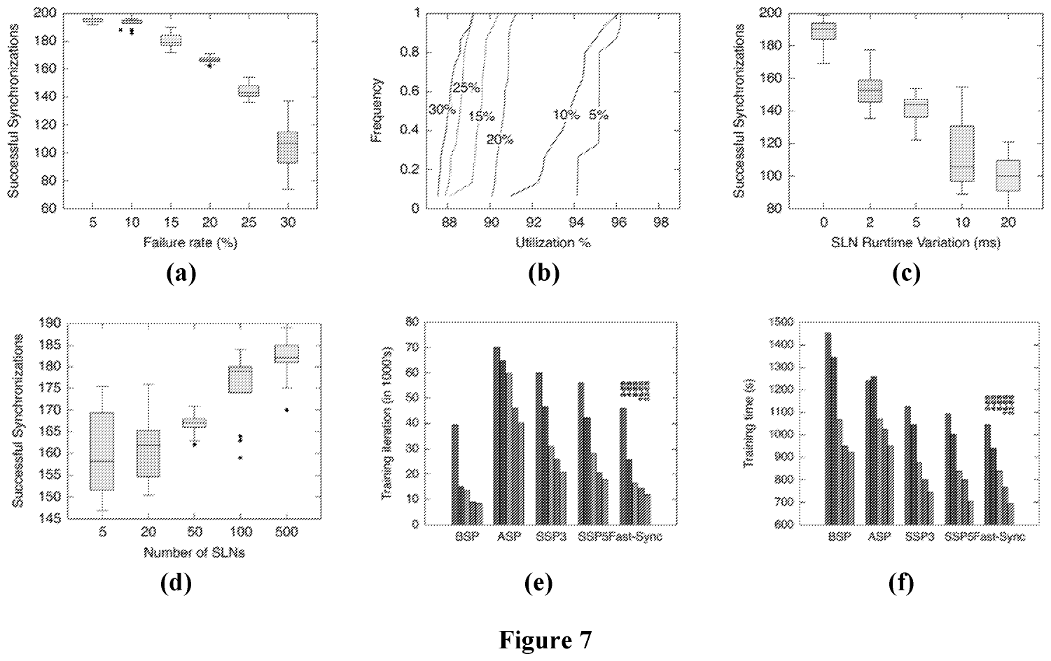

Referring to FIG. 9, there is provided a virtualization environment 900 in which functions and steps described herein can be implemented.

A virtualization environment (which may go beyond what is illustrated in FIG. 9), may comprise systems, networks, servers, nodes, devices, etc., that are in communication with each other either through wire or wirelessly. Some or all of the functions and steps described herein may be implemented as one or more virtual components (e.g., via one or more applications, components, functions, virtual machines or containers, etc.) executing on one or more physical apparatus in one or more networks, systems, environment, etc.

A virtualization environment provides hardware comprising processing circuitry 901 and memory 903. The memory can contain instructions executable by the processing circuitry whereby functions and steps described herein may be executed to provide any of the relevant features and benefits disclosed herein.

The hardware may also include non-transitory, persistent, machine-readable storage media 905 having stored therein software and/or instruction 907 executable by processing circuitry to execute functions and steps described herein.

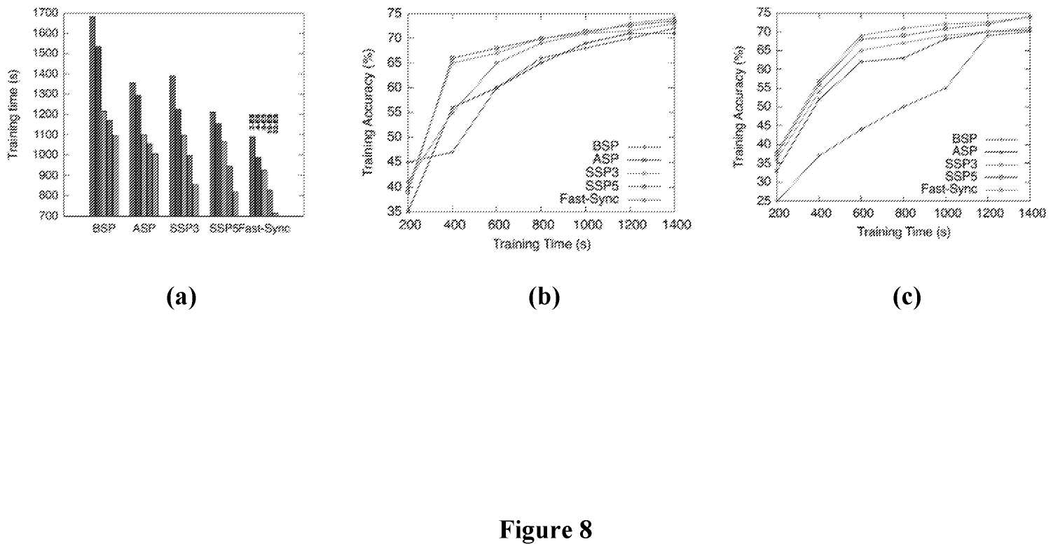

FIG. 10 illustrates a method 1000 for improving distributed training of an artificial intelligence (AI) model in an AI system comprising a plurality of edge servers and a plurality of edge devices. The method comprises synchronizing, step 1002, distributed data acquisition at a plurality of edge devices. The method comprises synchronizing, step 1008, the distributed training of the AI model at the plurality of edge servers, the AI model being trained using the synchronized data acquired from the plurality of edge devices.

Synchronizing the distributed data acquisition at the plurality of edge devices may comprise generating, step 1004, a data acquisition schedule, at each of the plurality of edge servers, the data acquisition schedule comprising synchronized data acquisition time intervals and guard time intervals. Synchronizing the distributed data acquisition at the plurality of edge devices may comprise sending, step 1006, the data acquisition schedule from each of the edge servers to a plurality of edge devices, thereby enabling the edge devices to schedule data acquisition within the data acquisition time intervals provided in the data acquisition schedule.

Asynchronized data acquisition tasks and local data acquisition tasks may be scheduled by the edge devices within the data acquisition time intervals.

The edge devices may have a goal to maximize a reward value and the edge devices may probe the edge servers within the guard time interval to get the reward value.

The reward value for an edge device may be a sum of all parameters β computed for all edge devices in communication with a same edge server, divided by the number of edge devices in communication with the same edge server, where the parameter β for a single edge device is calculated based on historical synchronization participation of the edge device in previous iterations, where, at each iteration, β is augmented by a first value for a successful synchronization or is being reduced by a second value for a failed synchronization, the second value being greater than the first value, and where β is set, in a first iteration, to an initial reward corresponding to a successful synchronization.

Synchronizing the distributed training of the AI model at the plurality of edge servers may comprise having a cloud controller, in communication with the edge servers, dividing, step 1010, the edge servers in at least two clusters; the cloud controller generating, step 1012, a synchronization schedule comprising three synchronization options per iteration for synchronizing the distributed training of the AI model. Synchronizing the distributed training of the AI model at the plurality of edge servers may comprise sending, step 1014, the synchronization schedule to the edge servers.

If one edge server detects that it will be late for a synchronization option because of a fault, a failure, a crash or another cause, the edge server may broadcast a message to all the edge servers, and all the edge servers may target the next synchronization option.

A decreasing reward value may be associated respectively with a first, second and third synchronization options and the clusters may have a common goal to maximize the reward value. The reward value may be increased for a cluster, when a broadcast message has been received from an edge server of another cluster, by running local tasks in the edge servers of the cluster while waiting for the next synchronization option.

The edge server tasks at each iteration of the synchronization schedule may comprise computing gradients and computing updated parameters for the AI model, using the synchronized data acquired from the plurality of edge devices.

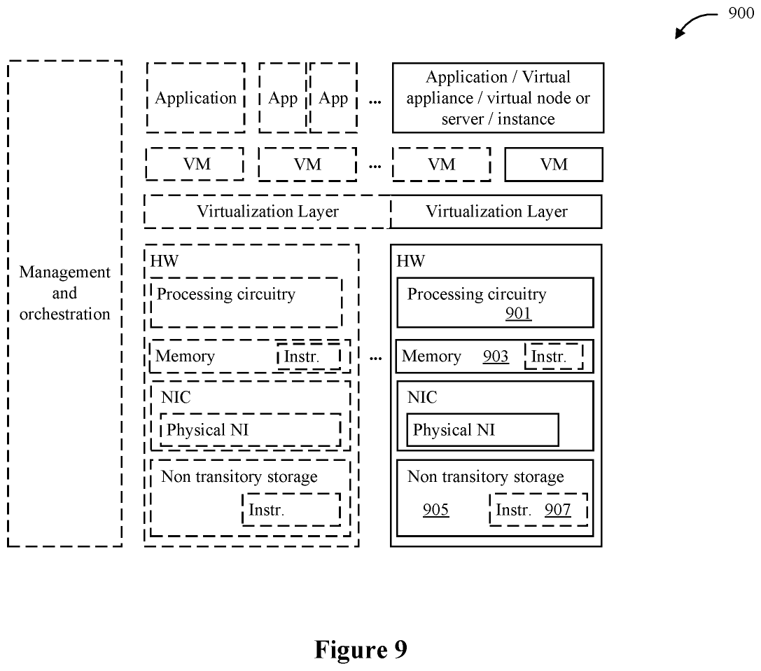

FIG. 11 illustrates a method 1100 executed in an edge device for synchronized data acquisition. The method comprises receiving, step 1102, a data acquisition schedule from an edge server, the data acquisition schedule comprising synchronized data acquisition time intervals and guard time intervals. The method comprises scheduling, step 1104, data acquisition within data acquisition time intervals provided in the data acquisition schedule.

The asynchronized data acquisition tasks and local data acquisition tasks may be scheduled within the data acquisition time intervals.

The edge device may have a goal to maximize a reward value and the edge device may probe the edge server within the guard time interval to get the reward value.

The reward value for the edge device may be a sum of all parameters β computed for all edge devices in communication with the edge server, divided by the number of edge devices in communication with the edge server, where the parameter β for the edge device is calculated based on historical synchronization participation of the edge device in previous iterations, where, at each iteration, β is augmented by a first value for successful synchronization or is being reduced by a second value for a failed synchronization, the second value being greater than the first value, and where β is set, in a first iteration, to an initial reward corresponding to a successful synchronization.

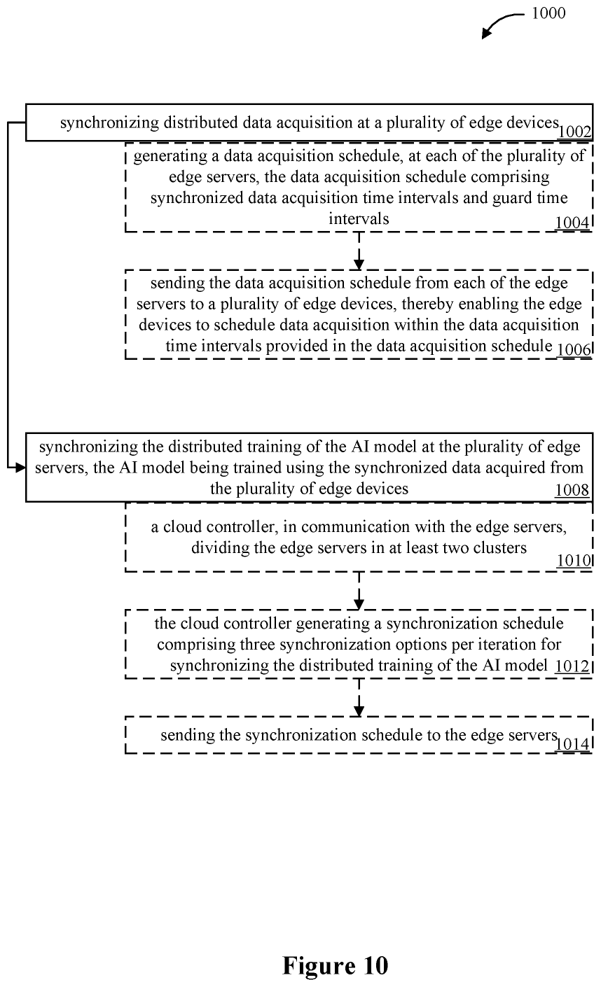

FIG. 12 illustrates a method 1200 executed in an edge server for synchronized data acquisition. The method comprises generating, step 1202, a data acquisition schedule, the data acquisition schedule comprising synchronized data acquisition time intervals and guard time intervals. The method comprises sending, step 1204, the data acquisition schedule to a plurality of edge devices, thereby enabling the edge devices to schedule data acquisition within the data acquisition time intervals provided in the data acquisition schedule.

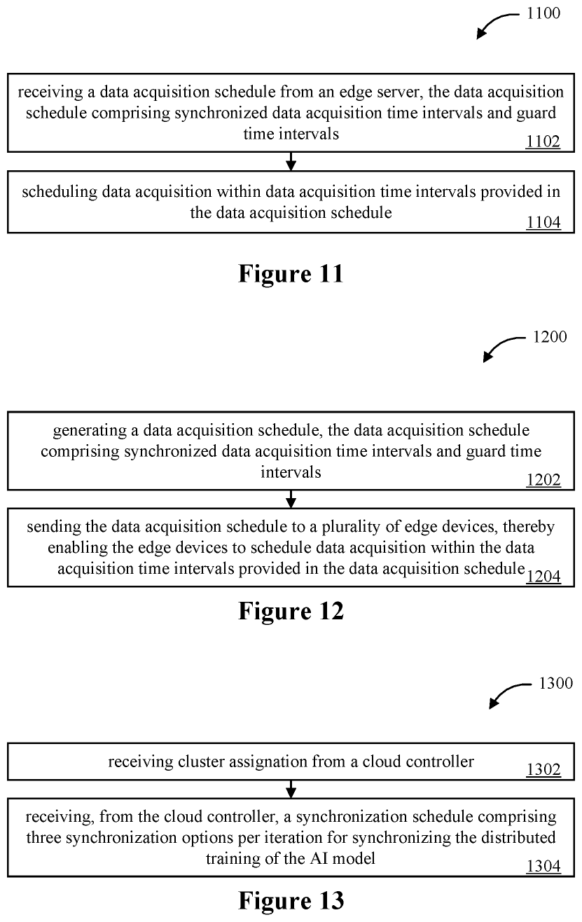

FIG. 13 illustrates a method 1300 executed in an edge server for synchronized distributed training of an artificial intelligence (AI) model. The method comprises receiving, step 1302, cluster assignation from a cloud controller. The method comprises receiving, step 1304, from the cloud controller, a synchronization schedule comprising three synchronization options per iteration for synchronizing the distributed training of the AI model.

If the edge server detects that will be late for a synchronization option because of a fault, a failure, a crash or another cause, the edge server may broadcast a message to all the edge servers, to indicate to all the edge servers to target the next synchronization option.

A decreasing reward value may be associated respectively with a first, second and third synchronization options and the clusters may have a common goal to maximize the reward value.

The reward value may be increased for a cluster, when a broadcast message has been received from an edge server of another cluster, by running local tasks in the edge server while waiting for the next synchronization option.

The edge server tasks at each iteration of the synchronization schedule may comprise computing gradients and computing updated parameters for the AI model, using the synchronized data acquired from the plurality of edge devices, and sending the updated parameters to the cloud controller.

Referring again to FIGS. 3 and 9, there is provided an artificial intelligence (AI) system 300, 900, for improving distributed training of an artificial intelligence (AI) model, the AI system comprising a plurality of edge servers 310 and a plurality of edge devices 305, each comprising processing circuits and a memory, the memory containing instructions executable by the processing circuits whereby the AI system is operative to synchronize distributed data acquisition at a plurality of edge devices and synchronize the distributed training of the AI model at the plurality of edge servers, the AI model being trained using the synchronized data acquired from the plurality of edge devices.

Still referring to FIGS. 3 and 9, there is provided an edge device 305 for synchronized distributed data acquisition comprising processing circuits and a memory, the memory containing instructions executable by the processing circuits whereby the edge device is operative to receive a data acquisition schedule from an edge server, the data acquisition schedule comprising synchronized data acquisition time intervals and guard time intervals and schedule data acquisition within data acquisition time intervals provided in the data acquisition schedule.

The asynchronized data acquisition tasks and local data acquisition tasks may be scheduled within the data acquisition time intervals.

The edge device may have a goal to maximize a reward value and the edge device may probe the edge server within the guard time interval to get the reward value.

The reward value for the edge device may be a sum of all parameters β computed for all edge devices in communication with the edge server, divided by the number of edge devices in communication with the edge server, where the parameter β for the edge device is calculated based on historical synchronization participation of the edge device in previous iterations, where, at each iteration, β is augmented by a first value for successful synchronization or is being reduced by a second value for a failed synchronization, the second value being greater than the first value, and where β is set, in a first iteration, to an initial reward corresponding to a successful synchronization.

Still referring to FIGS. 3 and 9, there is provided an edge server 310 for synchronized distributed training of an artificial intelligence (AI) model comprising processing circuits and a memory, the memory containing instructions executable by the processing circuits whereby the edge server is operative to generate a data acquisition schedule, the data acquisition schedule comprising synchronized data acquisition time intervals and guard time intervals, and send the data acquisition schedule to a plurality of edge devices, thereby enabling the edge devices to schedule data acquisition within the data acquisition time intervals provided in the data acquisition schedule.

Still referring to FIGS. 3 and 9, there is provided an edge server 310 for synchronized distributed training of an artificial intelligence (AI) model comprising processing circuits and a memory, the memory containing instructions executable by the processing circuits whereby the edge server is operative to receive cluster assignation from a cloud controller, and receive, from the cloud controller, a synchronization schedule comprising three synchronization options per iteration for synchronizing the distributed training of the AI model.

If the edge server detects that will be late for a synchronization option because of a fault, a failure, a crash or another cause, the edge server may broadcast a message to all the edge servers, to indicate to all the edge servers to target the next synchronization option. A decreasing reward value may be associated respectively with a first, second and third synchronization options and the clusters may have a common goal to maximize the reward value.

The reward value may be increased for a cluster, when a broadcast message has been received from an edge server of another cluster, by running local tasks in the edge server while waiting for the next synchronization option.

The edge server' tasks at each iteration of the synchronization schedule may comprise computing gradients and computing updated parameters for the AI model, using the synchronized data acquired from the plurality of edge devices, and sending the updated parameters to the cloud controller.

Referring to FIG. 9, there is provided a non-transitory computer readable media 905 having stored thereon instructions 907 for improving distributed training of an artificial intelligence (AI) model in an AI system, the instructions comprising synchronizing distributed data acquisition at a plurality of edge devices, and synchronizing the distributed training of the AI model at the plurality of edge servers, the AI model being trained using the synchronized data acquired from the plurality of edge devices.

The non-transitory computer readable media 905 may further comprise instructions 907 according to any of the steps described herein.

Modifications will come to mind to one skilled in the art having the benefit of the teachings presented in the foregoing description and the associated drawings. Therefore, it is to be understood that modifications, such as specific forms other than those described above, are intended to be included within the scope of this disclosure. The previous description is merely illustrative and should not be considered restrictive in any way. Although specific terms may be employed herein, they are used in a generic and descriptive sense only and not for purposes of limitation.

1. A method for improving distributed training of an artificial intelligence (AI) model in an AI system comprising a plurality of edge servers and a plurality of edge devices, comprising:
synchronizing distributed data acquisition at a plurality of edge devices; and
synchronizing the distributed training of the AI model at the plurality of edge servers, the AI model being trained using the synchronized data acquired from the plurality of edge devices.

2. The method of claim 1, wherein synchronizing the distributed data acquisition at the plurality of edge devices, comprises:
generating a data acquisition schedule, at each of the plurality of edge servers, the data acquisition schedule comprising synchronized data acquisition time intervals and guard time intervals; and
sending the data acquisition schedule from each of the edge servers to a plurality of edge devices, thereby enabling the edge devices to schedule data acquisition within the data acquisition time intervals provided in the data acquisition schedule.

3. The method of claim 2, wherein asynchronized data acquisition tasks and local data acquisition tasks are scheduled by the edge devices within the data acquisition time intervals.

4. The method of claim 3, wherein the edge devices have a goal to maximize a reward value and wherein the edge devices probe the edge servers within the guard time interval to get the reward value.

5. The method of claim 4, wherein the reward value for an edge device is a sum of all parameters β computed for all edge devices in communication with a same edge server, divided by the number of edge devices in communication with the same edge server,
wherein the parameter β for a single edge device is calculated based on historical synchronization participation of the edge device in previous iterations,
wherein, at each iteration, β is augmented by a first value for a successful synchronization or is being reduced by a second value for a failed synchronization, the second value being greater than the first value, and
wherein β is set, in a first iteration, to an initial reward corresponding to a successful synchronization.

6. The method of claim 1, wherein synchronizing the distributed training of the AI model at the plurality of edge servers, comprises:
a cloud controller, in communication with the edge servers, dividing the edge servers in at least two clusters;
the cloud controller generating a synchronization schedule comprising three synchronization options per iteration for synchronizing the distributed training of the AI model; and
sending the synchronization schedule to the edge servers.

7. The method of claim 6, wherein if one edge server detects that will be late for a synchronization option because of a fault, a failure, a crash or another cause, the edge server broadcasts a message to all the edge servers, and all the edge servers target the next synchronization option.

8. The method of claim 6, wherein a decreasing reward value is associated respectively with a first, second and third synchronization options and wherein the clusters have a common goal to maximize the reward value.

9. The method of claim 8, wherein the reward value is increased for a cluster, when a broadcast message has been received from an edge server of another cluster, by running local tasks in the edge servers of the cluster while waiting for the next synchronization option.

10. (canceled)

11. A method executed in an edge device for synchronized data acquisition, comprising:
receiving a data acquisition schedule from an edge server, the data acquisition schedule comprising synchronized data acquisition time intervals and guard time intervals; and
scheduling data acquisition within data acquisition time intervals provided in the data acquisition schedule.

12. The method of claim 11, wherein asynchronized data acquisition tasks and local data acquisition tasks are scheduled within the data acquisition time intervals.

13. The method of claim 11, wherein the edge device has a goal to maximize a reward value and wherein the edge device probes the edge server within the guard time interval to get the reward value.

14. The method of claim 13, wherein the reward value for the edge device is a sum of all parameters β computed for all edge devices in communication with the edge server, divided by the number of edge devices in communication with the edge server,
wherein the parameter β for the edge device is calculated based on historical synchronization participation of the edge device in previous iterations,
wherein, at each iteration, β is augmented by a first value for successful synchronization or is being reduced by a second value for a failed synchronization, the second value being greater than the first value, and
wherein β is set, in a first iteration, to an initial reward corresponding to a successful synchronization.

15. (canceled)

16. A method executed in an edge server for synchronized distributed training of an artificial intelligence (AI) model, comprising:
receiving cluster assignation from a cloud controller; and
receiving, from the cloud controller, a synchronization schedule comprising three synchronization options per iteration for synchronizing the distributed training of the AI model.

17. The method of claim 16, wherein if the edge server detects that will be late for a synchronization option because of a fault, a failure, a crash or another cause, the edge server broadcasts a message to all the edge servers, to indicate to all the edge servers to target the next synchronization option.

18. The method of claim 16, wherein a decreasing reward value is associated respectively with a first, second and third synchronization options and wherein the clusters have a common goal to maximize the reward value.

19. The method of claim 18, wherein the reward value is increased for a cluster, when a broadcast message has been received from an edge server of another cluster, by running local tasks in the edge server while waiting for the next synchronization option.

20. (canceled)

21. (canceled)

22. An edge device for synchronized distributed data acquisition comprising processing circuits and a memory, the memory containing instructions executable by the processing circuits whereby the edge device is operative to:
receive a data acquisition schedule from an edge server, the data acquisition schedule comprising synchronized data acquisition time intervals and guard time intervals; and
schedule data acquisition within data acquisition time intervals provided in the data acquisition schedule.

23. The edge device of claim 22, wherein asynchronized data acquisition tasks and local data acquisition tasks are scheduled within the data acquisition time intervals.

24. The edge device of claim 22, wherein the edge device has a goal to maximize a reward value and wherein the edge device probes the edge server within the guard time interval to get the reward value.

25. The edge device of claim 24, wherein the reward value for the edge device is a sum of all parameters β computed for all edge devices in communication with the edge server, divided by the number of edge devices in communication with the edge server,
wherein the parameter β for the edge device is calculated based on historical synchronization participation of the edge device in previous iterations,
wherein, at each iteration, β is augmented by a first value for successful synchronization or is being reduced by a second value for a failed synchronization, the second value being greater than the first value, and
wherein β is set, in a first iteration, to an initial reward corresponding to a successful synchronization.

26. (canceled)

27. An edge server for synchronized distributed training of an artificial intelligence (AI) model comprising processing circuits and a memory, the memory containing instructions executable by the processing circuits whereby the edge server is operative to:
receive cluster assignation from a cloud controller; and
receive, from the cloud controller, a synchronization schedule comprising three synchronization options per iteration for synchronizing the distributed training of the AI model.

28. The edge server of claim 27, wherein if the edge server detects that will be late for a synchronization option because of a fault, a failure, a crash or another cause, the edge server broadcasts a message to all the edge servers, to indicate to all the edge servers to target the next synchronization option.

29. The edge server of claim 27, wherein a decreasing reward value is associated respectively with a first, second and third synchronization options and wherein the clusters have a common goal to maximize the reward value.

30. The edge server of claim 29, wherein the reward value is increased for a cluster, when a broadcast message has been received from an edge server of another cluster, by running local tasks in the edge server while waiting for the next synchronization option.

31. (canceled)

32. (canceled)

33. (canceled)
